(19) United States
(12) Patent Application Publication
(10) Pub. No.: US 2020/0210160 A1
(43) Pub. Date: Jul. 2, 2020

(54) Data Polarization

(71) Applicant: Yelizar Aleksandr Dergachev, Columbia Heights, MN (US)

(72) Inventor: Yelizar Aleksandr Dergachev, Columbia Heights, MN (US)

(21) Appl. No.: 16/237,718

(22) Filed: Jan. 1, 2019

(51) Int. Cl. G06F 8/52; G06F 8/41; G06F 8/53

(52) U.S. Cl. CPC G06F 8/52; H04L 69/03; G06F 8/53; G06F 8/4432

(57) ABSTRACT

The Data Polarization process is completed on computer systems to make binary data information streams more efficient. The process does this by polarizing the binary segments and adding a signature to indicate how the segments were polarized for unpackaging. Polarizing in Data Polarization means that in all of the binary information segment, either all of the zeros are turned into ones, and ones turned into zeros. Afterwards, after computations or transmissions with the data package, with the signature, the information can be correctly interpreted and unpackaged. This helps computer systems use less energy in transmission and computation as less ones, or bursts of energy, are being used overall in the system, because of the optimized segments. This has many uses in a variety of computer systems including undersea cable relays, quantum computers, or Bitcoin miners.

### CROSS-REFERENCE TO RELATED APPLICATIONS

This is a nonprovisional application based off of the 62/612,124 granted provisional application titled Data Polarization.

### BACKGROUND OF THE INVENTION

A common goal of many computer system users, like Bitcoin miners, spacecraft, or operators of vast undersea communications lines is to reduce energy consumption to increase profits, or mission effectiveness. A conventional computer system use binary representation of information that is inherently energy inefficient. Binary strings of information are energy inefficient because it always predetermined that a one is a current applied, while a zero is a lack of current, over time, regardless of the actual information being computed or transmitted. Usually, continual streams of binary information is segmented in smaller parts to be transmitted separately. Some of these segments may have the capability to be more energy efficient if the ones in a segment, bursts of energy, are optimized.

### BRIEF SUMMARY OF THE INVENTION

Data Polarization works off the concept of zeros in binary strings of information being represented by no current, and the concept that it is the change in states between one and zero that truly represents the input information. This signature allows for each binary segment data package to have ones replaced to zeros, and zeros replaced with ones to have more zeros than ones. This allows for more energy efficient data packages being transmitted and computed with to lower energy consumption overall. To indicate how each data package segment was polarized for unpackaging, a separate signature is incorporated inside of the data package.

### DESCRIPTION OF THE DRAWINGS

FIG. 1 is a flowchart illustrating the combination of FIG. 1A and FIG. 1B. What is notable is that after a polarized data package with signature is created, computational operations may be performed on the package before the unpackaging and depolarization of the data package subsequently shown in FIG. 1B.

FIG. 1A is a flowchart subassembly of FIG. 1 illustrates how the data package is determined and assembled from a conventional binary data string.

FIG. 1B is a flowchart subassembly of FIG. 1 illustrates how the data package is read and reconverted back into a conventional binary data string.

FIG. 2 is a flowchart illustrating an example of how the Data Polarization process can be integrated into a system like an undersea cable relay. Aspects from FIG. 1A and FIG. 1B are required to understand the full meaning of the flowchart. The input data stream is one end of the cable to the other end of the cable.

### DETAILED DESCRIPTION OF THE INVENTION

### Concept of Process

Data Polarization is the process of making binary data information computation and transmission more energy efficient. Data Polarization works off the concept of zeros in binary strings of information being represented by no current, while ones are represented by a burst of energy, like current in a wire, or a blast of light. Data Polarization also works off of the concept that it is not necessary that the ones and zeros define binary information, but it is the changes between ones or zeros that can also define information. This untraditional approach allows Data Polarization to redefine a binary stream of information to have less ones, less bursts of energy, while retaining the original meaning of said information.

### Procedure of Process

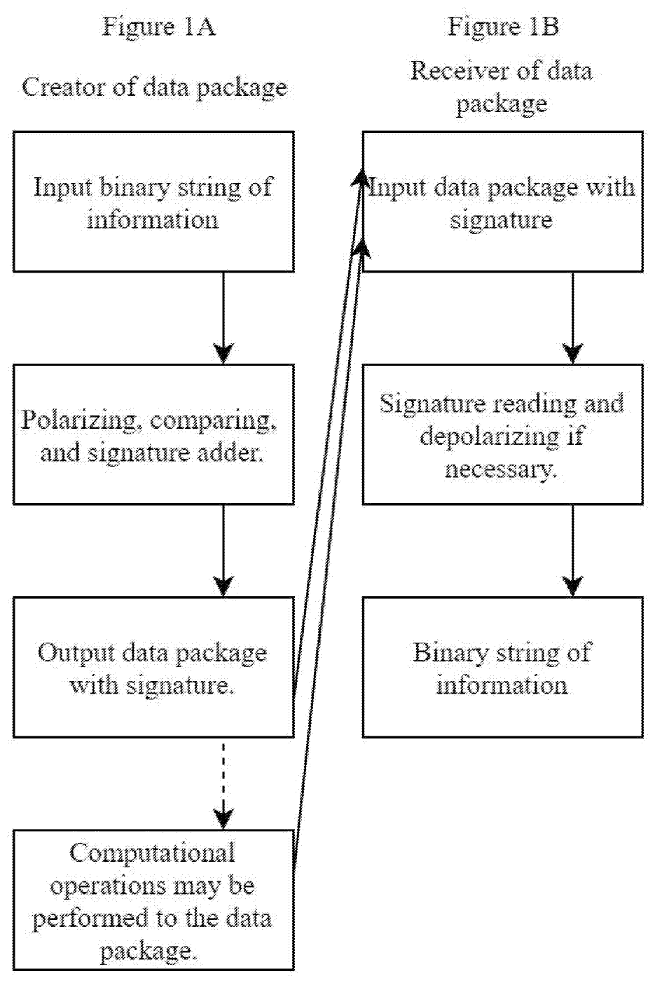

A binary continuous stream of data is usually segmented into smaller parts. The Data Polarization process would first compare an original segment string of binary information to a polarized option of said information. Polarization in Data Polarization is the act of creating an identical string of binary information, but with the all of the ones replaced with zeros, and all of the zeros replaced with ones. This polarization of the input data is compared with the actual original input data. Whichever options has less bursts of energy, which are usually ones, is chosen from this comparison. To indicate how the original input was polarized, a signifying signature is added to the output to form a data package. If the polarized option was chosen, then a signature of zero may be chosen. If the original input option was chosen, then a signature of one may be chosen. The exact signature does not have to be the one mentioned previously, but it should be a standard throughout systems to be interoperable. It should also be consistent and the polarized option signature must be a different value than the original input output signature. FIG. 1A is comprised of these steps.

Here is an example case:

This binary data string input is composed of 8 ones, and 2 zeros.

1111111100

This original input is then compared to a polarized option of said input.

111111100 Original input option. 8 ones, and 2 zeros
0000000011 Polarized option. 2 ones, 8 zeros

Clearly, the polarized option in this case has 6 less ones, 6 less bursts of energy.

To indicate that the polarized option was selected, a signature is added.
Here is an example format of the signature combined with the output data to form a data package.
00000000110

In this case, the last bit of the data package binary string is the signature, which in this case for a polarized option would be a zero.

Even after being processed by Data Polarization, it is still possible to complete useful computations on this data package.
As a result, comparing the original input to the produced data package, there is a saving of 6 energy bursts, and the binary string was increased from 10 bits to 11 bits in this case.
Although energy was used for the creation of this data package, more energy could be saved through less bursts of energy to transmit, or less bursts of energy managed through computational systems.

Because this Data Polarization process can be applied to a variety of computer systems, the exact signature does not have to be the one mentioned previously, but it should be a standard throughout systems to be interoperable. It should also be consistent and the polarized option signature must be a different value than the original input output signature. Logically, the signature should remain as a small part of the data package optimized to not add unnecessary computational or transmission energy costs that could minimize the efficiency of the Data Polarization process.

This defines the example based approach to explaining the Data Polarization process as illustrated in FIG. 1A.

To unpack the data package and retrieve the original input data, different steps must be taken. The signature must be interpreted in order to determine if it is necessary to depolarize the information. Depolarizing the information is similar to polarizing the information with the exception that it is occurring in the unpackaging phase of Data Polarization. All ones are still turned to zeros, and all zeros are still turned to ones.

The reader determines if the data package must be depolarized.
If the data package is or isn't depolarized, the read signature portion is removed and the original input data is outputted.
FIG. 1B is comprised of these steps.

Here is an example based approach to explaining the Data Polarization process as illustrated in FIG. 1B.

The presented binary string data package is the same as FIG. 1A's example based explanation.

00000000110

The signature is read, which is the last bit in this case, as a zero.

Because of interoperability standards throughout this case's computer system, it is interpreted that the data package is composed of polarized data.
Therefore, the data package must be depolarized.
11111111001

The signature must also be removed.

1111111100

It is not necessary that the signature removing step and depolarization step occur in this order, but it is necessary that these steps are correctly completed in order to interpret the original input information.

This defines the example based approach to explaining the Data Polarization process as illustrated in FIG. 1B.

All of the described Data Polarization phases and subprocesses are illustrated in FIG. 1.

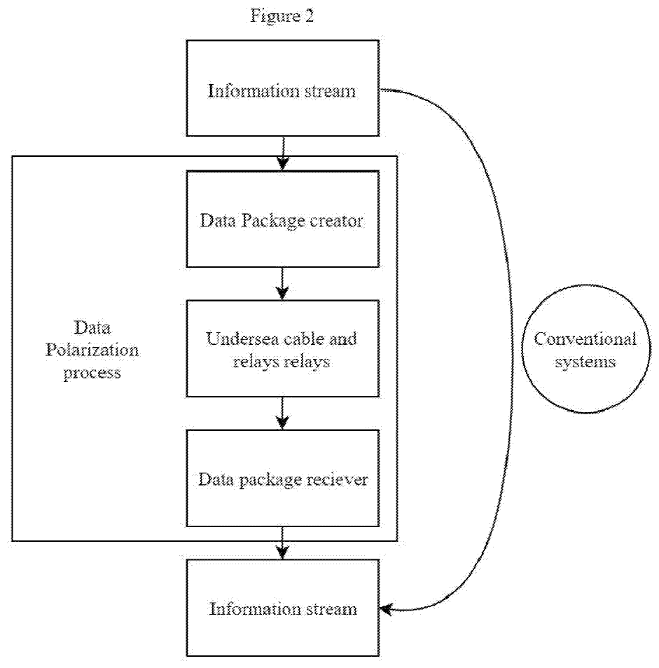

In FIG. 2, these steps may be implemented to integrate the Data Polarization process to undersea relays.

1. A process for optimizing binary data inputs, computed on a computer system that outputs one of two compared options, one of which is the original binary data input, and one of which is the polarized binary data input, whichever takes up less bursts of energy, as well as adding signature to indicate how the original information input was manipulated to create a data package comprised of the binary data output, and signature.

2. The process of claim 1, wherein to differentiate and interpret the processed data to retrieve useful information, a signature that may be a string of 1's can indicate that the data has been polarized, or may be a string of 0's can indicate that the data has not been polarized, is added to the output data to create a data package.

3. The data package may be transmitted, computed or manipulated, and be received to be unpackaged by interpreting the signature to see if the data in the data package has to be repolarized in order for the data to be interpreted as the original information.
